(19) United States
(12) Patent Application Publication
(10) Pub. No.: US 2012/0229851 A1
(43) Pub. Date: Sep. 13, 2012

(54) INFORMATION PROCESSING APPARATUS, PRINTING CONTROL SYSTEM, METHOD, AND STORAGE MEDIUM

(76) Inventor: Takayori NISHIDA, Tokyo (JP)

(21) Appl. No.: 13/409,885

(22) Filed: Mar. 1, 2012

(30) Foreign Application Priority Data
Mar. 11, 2011 (JP) 2011-054210
Nov. 29, 2011 (JP) 2011-261015

(51) Int. Cl. G06K 15/02

(52) U.S. Cl. 358/1.15

(57) ABSTRACT

An information processing apparatus is connected to a plurality of job servers storing a plurality of jobs and a plurality of image forming apparatuses executing the jobs through a communication network. The information processing apparatus includes a communication interface that receives a request for a job list of a user from an image forming apparatus and a controller unit that controls a request for acquiring the jobs and a response to the request executed between the image forming apparatuses and the job servers.

### CROSS-REFERENCE TO RELATED APPLICATIONS

The present application claims priority under 35 U.S.C. §119 to Japanese Patent Application No. 2011-054210 filed in Japan on Mar. 11, 2011 and Japanese Patent Application No. 2011-261015 filed in Japan on Nov. 29, 2011, the entire contents of both of which are hereby incorporated by reference.

### BACKGROUND

1. Technological Field

The present invention relates to pull print system, wherein an image forming apparatus acquires a printing job stored in server, and prints.

2. Description of the Related Art

Japanese Patent Application Laid-open No. 2008-140089 describes pull print system which includes printing control server.

In this system, a user can store a printing job in printing control server without designating a printer which prints the printing job. The stored job is then printed with a printer that is subsequently selected.

### SUMMARY

However, in conventional pull print systems, there may be a case where the user can not select the printing job, which the user wants to execute, in the printing job list screen displayed on the printer.

Conventionally, the printing control server that is connected to the printer is designated, in a limited way, from among a plurality of printing control servers in the system by an administrator. Thus, in the case in which the printing control server designated by the administrator does not store the printing job of the user, the user cannot select the printing job from the printing job list.

These cases tend to occur in a wide area system. Generally, the printing control server s tends to be set for each area such as an office. In this case, the administrator designates the printing control server that is locally connected to the printer (i.e., same local area network or LAN) and is in the same area or office. This designation by the administrator is because the area in which the printer is located tends to be the area in which the user is located, and the user tends to store jobs in the printing control server that is locally connected to the printer. Thus, in the case in which the user is located in a area which is not the same as the area the user is usually located in, the user cannot execute the stored the printing job because the stored printing job is stored in a printing control server that is not designated for the printer that is physically located at the user's current location (which is different from the user's usual location where the print control server may be disposed).

Exemplary embodiments described herein provide information processing apparatus, a printing control system, a printing control method, a storage medium which enable the user to execute a printing job with the image forming apparatus, in the case in which the user stores the printing job in a plurality of print control servers that are in different areas.

An information processing apparatus which is connected to a plurality of job servers storing a plurality of jobs and a plurality of image forming apparatuses executing the jobs through a communication network, including: a communication interface that receives a request for a job list of a user from an image forming apparatus; and a controller unit that controls a request for acquiring the jobs and a response to the request for the job list, wherein the controller unit acquires display information which includes the job list of the user, from a job server located in a area which is different from an area in which the image forming apparatus is located, based on a request for acquiring the display information received from the image forming apparatus, and transmits the display information to the image forming apparatus, the controller unit acquires job data from the job server storing the job which is designated for execution based on a request for acquiring an execution job received from the image forming apparatus, and the controller unit transmits the job data to the image forming apparatus.

A job control method executed in information processing apparatus which is connected to a plurality of job servers storing a plurality of jobs and a plurality of image forming apparatuses executing the jobs through a communication network, said method including: receiving, with a communication interface, a request for a job list of a user from an image forming apparatus; controlling, with a controller unit, a request for acquiring the jobs and a response to the request for the job list; acquiring, with the controller unit, display information which includes the job list of the user, from a job server located in a area which is different from an area in which the image forming apparatus is located, based on a request for acquiring the display information received from the image forming apparatus; transmitting, with the controller, the display information to the image forming apparatus; acquiring, with the controller unit, job data from the job server storing the job which is designated for execution based on a request for acquiring an execution job received from the image forming apparatus; and transmitting, by the controller unit, the job data to the image forming apparatus.

In the printing control function, the information processing apparatus communicatively located between a plurality of the job server storing the jobs and a plurality of the image forming apparatus executing the jobs, controls the request for acquiring data and the response processing processed among the two sides of apparatus.

Thus, it can be provided that a information processing apparatus, a printing control system, a printing control method, a storage medium which makes the user to be able to execute the intended printing job with the image forming apparatus, in the case in which the user stores the printing job in the plurality of store destinations which are set in different areas.

### BRIEF DESCRIPTION OF THE DRAWINGS

FIG. 1 is a diagram illustrating a printing control system according to a first embodiment;

FIG. 2 is a block diagram of a hardware configuration of a web server according to the first embodiment;

FIG. 3 is a block diagram of a hardware configuration of an image forming apparatus according to the first embodiment;

FIG. 4 is a diagram illustrating a function configuration of printing control according to the first embodiment;

FIG. 5 is a diagram illustrating one example of data of control information according to the first embodiment;

FIG. 6 is a diagram illustrating one example of job list data according to the first embodiment;

FIG. 7 is a diagram illustrating one example of job execution operation screen according to the first embodiment;

FIG. 8 is a sequence diagram illustrating a procedure for a process of printing control according to the first embodiment;

FIG. 9 is a sequence diagram illustrating a procedure for a process of showing an extended job list according to the first embodiment;

FIG. 10 is a flowchart illustrating a procedure for a control of showing a basic job list and the extended job list according to the first embodiment;

FIG. 11 is a diagram illustrating the printing control system according to a second embodiment;

FIG. 12 is a diagram illustrating a function configuration of printing control according to the second embodiment;

FIG. 13 is a diagram illustrating one example of user identification information according to the second embodiment; and

FIG. 14 is a flowchart illustrating a procedure for a display control of the basic job list and the extended job list according to the second embodiment.

### DETAILED DESCRIPTION OF THE PREFERRED EMBODIMENTS

Hereinafter, exemplary embodiments will be described with reference to the accompanying drawings. However, the present invention is not limited to the exemplary embodiments, and variations and modifications may be made without departing from the basic concepts of the present invention as claimed.

### A First Embodiment

[System Configuration]

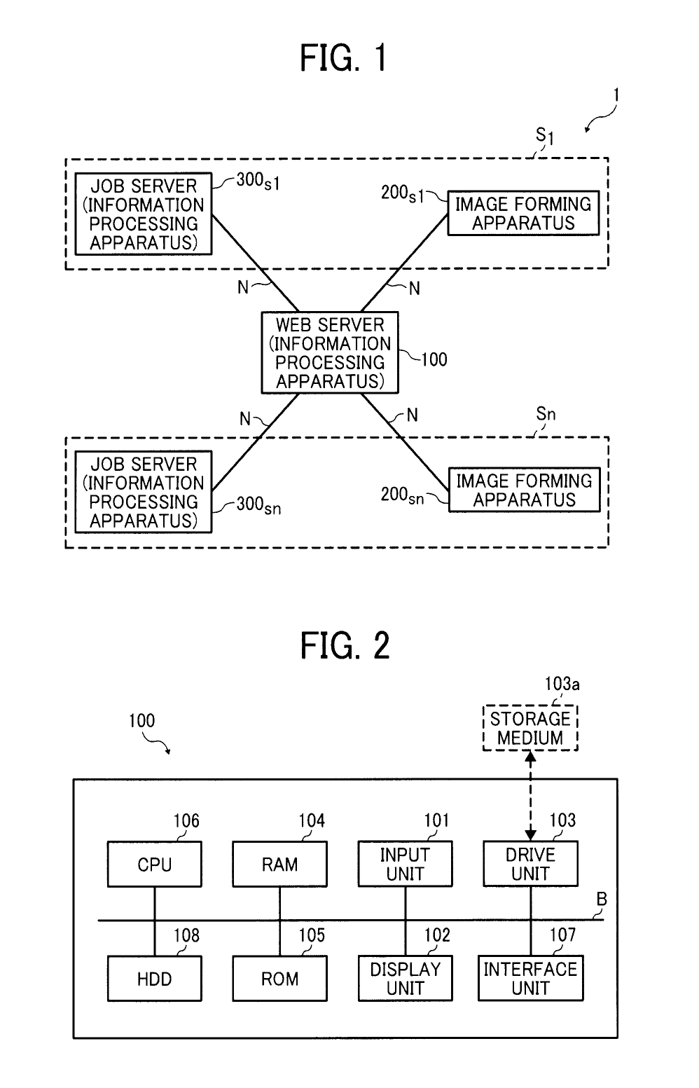

FIG. 1 is a diagram illustrating a printing control system 1 according to the first embodiment. FIG. 1 illustrates one example of system configuration which includes a plurality job server 300s1 to 300sn (collectively referred to as “ job server 300s”, hereinafter), image forming apparatuses 200s1 to 200sn (collectively referred to as “an image forming apparatus 200s”, hereinafter) and a web server 100, which are mutually connected to each other by a communication network N (for example, Wide Area Network (WAN)).

Also, the printing control system 1 illustrates Areas S1-Sn (collectively referred to as “a set area S”, hereinafter) in which the job server 300s or the image forming apparatus 200s are physically located. These set areas S are something such as an office.

Also, the job server 300s is connected to the communication network N in the printing control system 1, and is communicatively between the job server 300s and image forming apparatus 200s. Thus, the job server 300s and the image forming apparatus 200s execute data communication through the web server 100 in the printing control system 1 according to this embodiment.

Below, exemplary implementations will be described. The job server 300s is a server which comprises a function of managing the stored job.

The job server 300s is a job storing apparatus implemented, for example, by a personal computer (PC).

The job server 300s receives job data, which includes various execution settings, from an information processing terminal. The job server 300s stores the job in a particular storage area and manages the job. The image forming apparatus 200s is an apparatus which comprises a function of processing image data. The image forming apparatus 200s is implemented, for example, by with a laser printer (LP) or a multifunction peripheral (MFP). In the case in which image forming apparatus 200s is implemented with MFP, the job server 300s comprises a copy function, a scan function and print function as image processing function.

The web server 100 is a server which comprises a function of relaying data communications between the job server 300s and the image forming apparatus 200s. The web server 100 is implemented, for example, by a personal computer (PC). The web server 100 provides a function of relaying the data communication, by using a web service (Hypertext Transfer Protocol: HTTP), to the job server 300s and the image forming apparatus 200s. When the web server 100 receives a request for acquiring the job list, through the web service, from the image forming apparatus 200s, the web server 100 acquires the job list, which may be a summary of the printing jobs) from the job server 300s in compliance with the request for acquiring the job list. The web server 100 sends the acquired job list to the image forming apparatus 200s. Further, when the web server 100 receives a request for acquiring an execution job, through the web service, from the image forming apparatus 200s, the web server 100 acquires job data from the job server 300s in compliance with request for acquiring the execution job. The web server 100 sends the acquired job data to the image forming apparatus 200s. As just described, the web server 100 controls the request for acquiring the data about the job and the response to the request job data, which is executed between the job server 300s and the image forming apparatus 200s.

The printing control system 1 provides a service described below to a user. For example, the user sends the job data which includes various execution settings with the information processing terminal, establishes a location for the job server 300s1 in the area s1, which is the area the user belongs to, and the job server 300s1 stores the job data. The user moves to an areaₛₙ, which is different from the area s1 the user belongs to, and the user attempts to execute the job stored in the job server 300s1 with the image forming apparatus 200sn in the area,. Firstly, the user logs into the image forming apparatus 200sn. When the user logs into the image forming apparatus 200sn, the job list is acquired from the job server 300s1 through the web server 100. The job list is displayed on the screen of the image forming apparatus 200sn. The user selects a job from the job list to direct the image forming apparatus 200sn to execute the job. When the user selects a job, the image forming apparatus 200sn prints the job data acquired from the job server 300s1 through the web server 100.

As described above, the printing control system 1 according to this embodiment can provide printing control services for jobs stored in the plurality of the job server 300s which are set in different area S than the image forming apparatus.

[Hardware Configuration]

[Web Server]

FIG. 2 is a block diagram of an exemplary hardware configuration of the web server 100 according to the first embodiment. The hardware configuration of the job server 300s may be the same as the web server 100.

As illustrated in FIG. 2, the web server 100 includes an input unit 101, a display unit 102, a drive unit 103, a random access memory (RAM) 104, a read only memory (ROM) 105, a central processing unit (CPU) 106, an interface unit 107 and a hard disk drive (HDD) 108, which are mutually connected to each other by a bus B.

The input unit 101 includes a keyboard, a mouse, and/or a touch screen. Other input devices may also be used. The input unit 101 is used for inputting commands to the web server 100. The display unit 102 includes a display, such as an LCD display. Other displays device may also be used. The display unit 102 displays output processed by the web server 100.

The interface unit 107 is an interface which connects the web server 100 to the communication network N. The network interface may use, for example, Ethernet. Other communication standards may also be used with the interface, including wireless communication standards. Thus, the web server 100 can perform data communication with the job server 300s and the image forming apparatus 200s through the interface unit 107.

The HDD 108 is a nonvolatile storage apparatus which stores programs and data. There are information processing systems (for example, “Windows (Trade Mark)” and “UNIX (Trade Mark)”) which control the apparatus with programs and data. There are applications which provide each function on the system.

Also, the HDD 108 manages the stored programs and the stored data with a file system and/or a data base (DB). The HDD 108 stores instructions, which when executed, configure the CPU 106 to execute the instructions in order to provide the functional aspects described herein.

The drive unit 103 is an interface to a detachable storage medium 103a. Thus, the web server 100 can perform reading from and/or writing in the detachable storage medium 103a through the drive unit 103. The detachable storage medium 103a may be a floppy disc, a compact disc (CD), a digital versatile disc (DVD), a SD memory card and an universal serial bus memory (USB).

The ROM 105 is a nonvolatile semiconductor memory (storage apparatus) which can store data when the power is off. The ROM 105 includes basic input/output system (BIOS), which is executed when the web server 100 executes programs and data about information processing system settings and network settings.

The RAM 104 is a nonvolatile semiconductor memory (storage apparatus) which stores programs and data temporarily.

The CPU 106 reads out programs and data from the HDD 108, the storage medium 103a, and/or the ROM 105. The CPU 106 also stores data and/or programs in the RAM 104. The CPU 106 manages the apparatus and realizes a function of the apparatus through executing software or instructions.

The web server 100 and the job server 300s may omit several of the elements shown in FIG. 2, which may include the omission of the input unit 101 and the display unit 102. Other elements may be omitted in other embodiments.

[image processing apparatus]

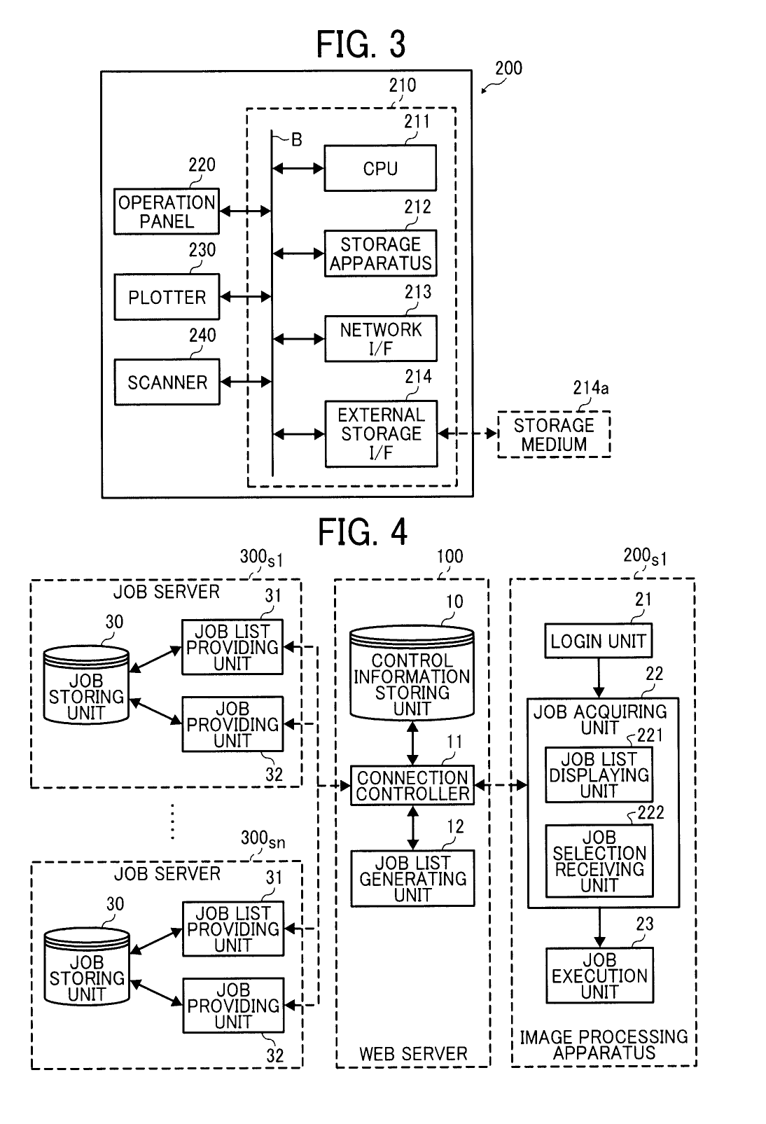

FIG. 3 is a block diagram of a hardware configuration of the image forming apparatus 200 according to the first embodiment. As illustrated in FIG. 3, the image forming apparatus 200s includes the controller 210, the operation panel 220, the plotter 230 and the scanner 240, which are mutually connected to each other by the bus B.

The operation panel 220 includes a display unit and an inputting unit. The operation panel 220 provides various information, such as machine status information and machine operation information, to a user, and receives various user operations, such as a performance setting and a performance direction. Further, the job list received from the web server 100 is displayed on the display unit of the operation panel 220. The operation panel 220 receives a direction to execute the job with the inputting unit such as graphical use interface (GUI).

The plotter 230 includes an image forming unit, and forms output images on sheets. There are a plurality of methods of forming output images, such as electrophotographic process and ink jet process. The scanner 240 scans documents optically, and generates scanned images.

The controller 210 includes the CPU 211, the storage apparatus 212, and the network I/F 213, which are mutually connected to each other by the bus B.

The CPU 211 controls a whole apparatus by executing programs and/or instructions.

The storage apparatus 212 stores various programs and data (such as “image data”).

The storage apparatus 212 may be RAM which is a volatile semiconductor memory, ROM which is a nonvolatile semiconductor memory, and a HDD which has large storage area. These are merely examples, and other storage media or devices may be utilized as the storage apparatus 212. The RAM acts as a storage area on which programs and data are read out temporally (a work area) by the CPU 211. The ROM and the HDD are used as storage locations for programs and various data. Thus, the CPU 211 reads out the programs stored in the ROM, stores the programs in the RAM, and executes the programs in the image forming apparatus 200s.

The network I/F 213 is an interface for connecting the image forming apparatus 200s to the communication network N, such as the Internet or an intranet. The external storage I/F 214 is an interface for connecting to storage medium 214a which is the external storage medium. The storage medium 214a may be SD memory card or universal serial bus memory (USB memory). Thus, the image forming apparatus 200s reads out the programs and the data from storage medium 214a through the external storage I/F 214.

[Printing Control Function]

The printing control function according to this embodiment will be described below. The web server 100 according to this embodiment is located between a plurality of the job server 300s storing the jobs and a plurality of the image forming apparatus 200s that may execute the jobs. The web server 100 controls the request for acquiring data and the response processing processed among the two sides of apparatus.

The web server 100 acquires the job list from the job server 300s located in one or more areas which are different from the area in which the image forming apparatus 200s is located, in response to the request for the job list that is received from the image forming apparatus 200s. The web server 100 transmits the acquired job list to the image forming apparatus 200s. Thus, a list of the jobs, which is stored in the one or more job server 300s located in areas which are different from the area in which the image forming apparatus 200s is located, are displayed on the image forming apparatus 200s. The web server 100 acquires the job data from the job server 300s storing the job designated for execution, in response to the request received from the image forming apparatus 200s. The web server 100 transmits the acquired job data to the image forming apparatus 200s.The received job data is printed on the image forming apparatus 200s. Thus, the job which the user wants to execute is executed.

Conventionally, in a wide-area system, there has been a case where the user cannot select the printing job that the user wants to execute from the printing job list screen displayed on the image forming apparatus 200. Generally, this issue arises because the job server 300s storing the b is only accessible from the image forming apparatus disposed in a same area (such as an office) as the job server 300s. The job server 300s disposed in the same area with the image forming apparatus 200s is designated as the job server 300s for that image forming apparatus 200s by the administrator. The image forming apparatus 200s is not communicatively coupled to other job servers. Thus, in the case in which the user moves to another area which is different from the job server that stores the user's job, the user cannot execute the job because the job server storing the user's job cannot be accessed from an image forming apparatus in the another area. Thus, the printing control server being communicatively in between the image forming apparatus and the job server in the communication network enables the user to select a printing job from a job server that is not in the same area as the image forming apparatus.

Thus, in the printing control system 1 according to this embodiment, there are a plurality of the job servers 300s in various areas, and the user can select with an image forming apparatus 200s the job the user want to execute from any of the plurality of job servers.

A configuration of the printing control function and a performance of the printing control function will be described below.

FIG. 4 is a diagram illustrating the function configuration of the printing control according to the first embodiment. As illustrated in FIG. 4, the printing control function according to this embodiment includes a connection controller 11, a job list generating unit 12, a login unit 21, a job acquiring unit 22, a job execution unit 23, a job list providing unit 31 and the job providing unit 32. The connection controller 11 and the job list generating unit 12 are included in the web server 100. The login unit 21, the job acquiring unit 22 and the job execution unit 23 are included in the image forming apparatus 200s. The job list providing unit 31 and the job providing unit 32 are included in the job server 300s.

### [The Job Server]

The job list providing unit 31 sends (provides) the job list, which is a list of stored jobs, in response to the request for acquiring, to the apparatus which requested the job list. These function units access a job storing unit 30 which stores the job data received from the user, and acquires the data requested.

An example of management of the stored job, executed by the job storing unit 30, will be described below. Management information may include information items, such as a job identification and a job attribute associated with each other. The management information is associated with the stored job data. The “job identification” item is an item which stores information distinguishing the stored job. The “job identification” may be a job ID and may include an identifier of the job server on which the job is stored. The “job attribute” may include one or more of a job name, a user name, stored date and hour, and a number of pages. Other information may be included in the “job attribute,” such as file type or other metadata associated with the job. The job attribute may be acquired by executing data analysis and extracting bibliographic information included in the job data, when the job data is stored. Alternatively, the content of the job attribute may be provided by a user.

The job list providing unit 31 receives information distinguishing a user, such as the user name, from the request for acquiring the job list. The job list providing unit 31 acquires management information corresponding to the user identification information, with reference to the job storing unit 30, based on the user identification information. The job list providing unit 31 generates the job list. Thus, the job list providing unit 31 provides the requested job list.

The job providing unit 32 identifies the management information corresponding to job identification information, with reference to the job storing unit 30, based on job identification information such as the job ID. Herewith, the job providing unit 32 acquires the job data corresponding to job identification information. Thus, the job providing unit 32 provides the job data requested.

[Web Server]

The connection controller 11 controls a connection between the job server 300s and the image forming apparatus 200s on the communication network N. The web server 100 relays the data and communications between the job server and the image forming apparatus.

The connection controller 11 accesses a control information storing unit 10, which stores control information. The connection controller 11 controls the connection between the job server 300s and the image forming apparatus 200s based on a connection rule set in the control information.

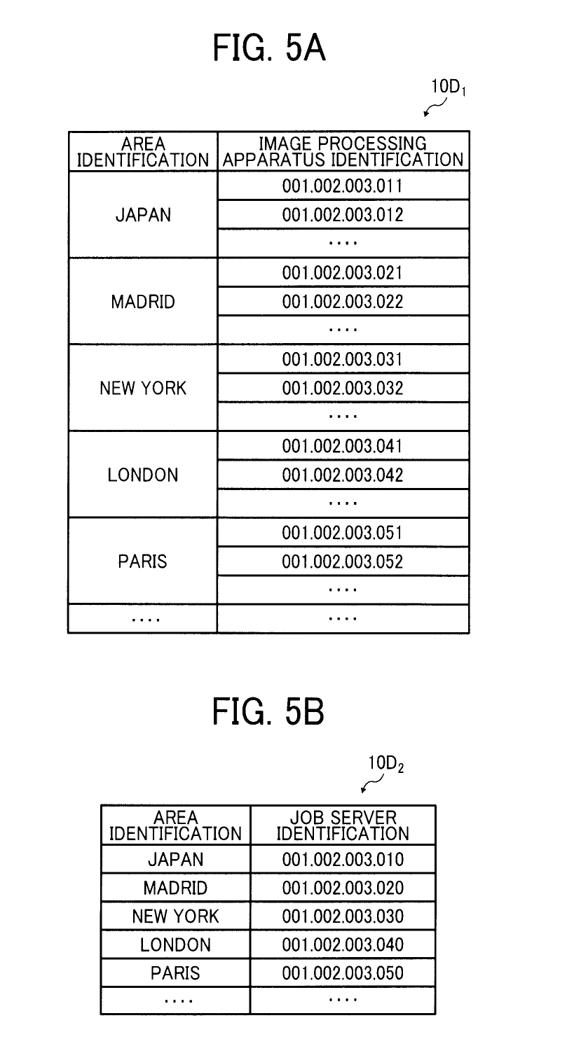

FIG. 5 is a diagram illustrating one example of control information 10D1, 10D2 according to the first embodiment. As illustrated in FIG. 5, there are two types of the control information; the control information 10D1 and the control information 10D2 (collectively referred to as “control information 10D”, hereinafter). The control information 10D1 includes an identifier of the image forming apparatus 200s corresponding to an area identifier for each set area S (referred to as “image processing apparatus information 10D1”, hereinafter), and is illustrated in FIG. 5 (A). The control information 10D2 includes an identifier of the job server 300s corresponding to an area identifier for each set area S (referred to as “job server information 10D2”, hereinafter), and is illustrated in FIG. 5 (B).

The “area identification” item may be an area name. The “the image processing apparatus identification” item may be an identifier of the image forming apparatus 200s (referred to as “the machine identification information”, hereinafter), which may be a network address (internet protocol address or IP address). The “job server identification” item may be an item which identifies the job server 300s (referred to as “server identification information”, hereinafter), and may be network setting information or a network address.

The area identification, the image processing apparatus identification, and the job server identification items may be set by the administrator. Conventionally, the control information 10D has been stored in each job server 300s and management of the control information 10D has been executed at each job server 300s. However, in this embodiment, the control information 10D is managed by the web server 100 collectively. Thus, an operation of management is simplified, and administrator's burden is reduced.

Referring back to FIG. 4, the job list generating unit 12 is a unit which generates the job list sent to the image forming apparatus 200s. The job list generating unit 12 receives the job list from the job server 300s and generates the job list sent to the image forming apparatus 200s by adding the server identification information to the job list. Further, when the web server 100 receives a plurality of job lists from a plurality of the job server 300s, the job list generating unit 12 generates the job list sent to the image forming apparatus 200s by aggregating (merging) the job lists into one job list. The job list which is made by aggregating (merging) the job lists will be referred to as “consolidated job list”.

In this embodiment, when the job server 300s receives the request for acquiring the job list from the image forming apparatus 200s, the connection control and process of generating the job list, which will be described below, is performed.

When the web server 100 receives the request for acquiring the job list which is sent along with a login of the user from the image forming apparatus 200s1, the web server 100 receives the user identification information and the machine identification information from the image forming apparatus 200s1.

When the web server 100 receives the user identification information and the machine identification information, the connection controller 11, with reference to the image processing apparatus information 10D1 stored in the control information storing unit 10 based on the machine identification information, acquires the area identification information corresponding to the machine identification information. The connection controller 11 determines the set area S1 in which the image forming apparatus 200s1 is set, based on the area identification information. The connection controller 11, with reference to the job server information 10D2 stored in the control information storing unit 10 based on the area identification information, acquires the server identification information corresponding to the area identification information. The connection controller 11 determines the job server 300s1 which is connected to the image forming apparatus, based on the server identification information.

Next, the connection controller 11 requests the job list by sending the received user identification information to the determined job server 300s1. The connection controller 11 receives the job list of the user from the job server 300s1. The connection controller 11 relays the job list to the job list generating unit 12. The job list generating unit 12 generates the job list sent to the image forming apparatus 200s1 by adding the server identification information 300s1 to the job list. Further, the job list generating unit 12 relays the generated job list to the connection controller 11. The connection controller 11 sends the received job list to the image forming apparatus 200s1 which sent the request for acquiring job list. Thus, the job list of the user, which includes jobs stored in the job server 300s1, is displayed on the image forming apparatus 200s.

In the case in which the job which the user wants to execute is displayed in the job list, the user selects the job on the screen, and directs the image forming apparatus 200s1 to execute the job.

When the web server 100 receives the request for acquiring the job data from the image forming apparatus 200s1, the web server 100 receives the job identification information and the server identification information from the image forming apparatus 200s1.

Next, the connection controller 11 requests to acquire the job data by sending the job identification information to the job server 300s1 which is identified by the server identification information. The connection controller 11 receives the job data from the job server 300s1. The connection controller 11 sends the received job data to the image forming apparatus 200s1 which sent the request for acquiring the execution job. Consequently, the image forming apparatus 200s1 executes or prints the received job data.

In the case in which the job the user wants to executes is not displayed in the job list, the user directs, on the screen of the image forming apparatus 200s1, to alter the job server 300s from which the job list is acquired from to one or more other job servers 300s (which are located in different areas than the job server 300s1).

When the web server 100 receives the request for acquiring the job list along with a request to alter the job server 300s, the web server 100 receives the user identification information and the machine identification information from the image forming apparatus 200s1.

When the web server 100 receives the user identification information and the machine identification information, the connection controller 11, with reference to the image processing apparatus information 10D1 stored in the control information storing unit 10 based on the machine identification information, acquires the area identification information corresponding to the machine identification information. The connection controller 11 determines the set area S1 in which the image forming apparatus 200s1 is set, based on the area identification information. The connection controller 11 identifies the one or more areasₛₙ which are different from area S1. The connection controller 11, with reference to the job server information 10D2 stored in the control information storing unit 10 based on the area identification information, acquires the server identification information corresponding to the area identification information identifying areas different from S1. Thus, the connection controller 11 determines the one or more job servers 300snwhich are connected to the web server 100, in areas that are different than S1.

Next, the connection controller 11 requests the job list by sending the received user identification information to the determined one or more job servers 300sn. The connection controller 11 receives the job list of the user from the one or more job servers 300sn. The connection controller 11 relays the job list to the job list generating unit 12. The job list generating unit 12 generates the job list sent to the image forming apparatus 200s1 by adding the one or more server identification information 300s1 to the job list. Further, the job list generating unit 12 relays the generated job list to the connection controller 11. When the job list generating unit 12 receives a plurality the job lists, the job list generating unit 12 generates the consolidated job list and relays the consolidated job list to the connection controller 11. The connection controller 11 sends the received job list to the image forming apparatus 200s1 which sent the request for acquiring the job list. Thus, the job list of the user, which includes jobs stored in the one or more job server 300sn that are in an area or areas different from the image forming apparatus 200s1, is displayed on the image forming apparatus 200s.

In order to execute a job, the user selects the job on the screen from the displayed job list, and directs the image forming apparatus 200s1 to execute or print the job.

Consequently, in the printing control system 1, in the case in which the user moves to the area which is different from the area in which the job server 300sn storing the user's job is located, the user can select and execute the job stored in the job server 300sn with the image forming apparatus 200s1 located in an area different from the job server 300sn.

[Image Forming Apparatus]

The login unit 21 is a function unit which executes login processing for the user. The login unit 21 acquires login information including the user identification information by receiving an input operation which the user inputs on the login screen displayed on the operation panel 220 of the image forming apparatus 200s. Receiving login information is not limited to the input of the information on the login screen. For example, the login unit 21 may receive the login information by reading the storage medium 214a, which stores the login information of the user, connected to the image forming apparatus 200s through the external storage I/F 214.

The job acquiring unit 22 is a function unit which acquires the stored job in the job server 300s. As described above, the image forming apparatus 200s displays the job list of the user on the operation panel 220. When the user selects the job in the job list, the job acquiring unit 22 receives a direction to execute the job. Thus, the image forming apparatus 200s acquires the job data corresponding to the selected job from the job server 300s through the web server 100. For realizing these functions, the job acquiring unit 22 includes a job list displaying unit 221 and a job selection receiving unit 222.

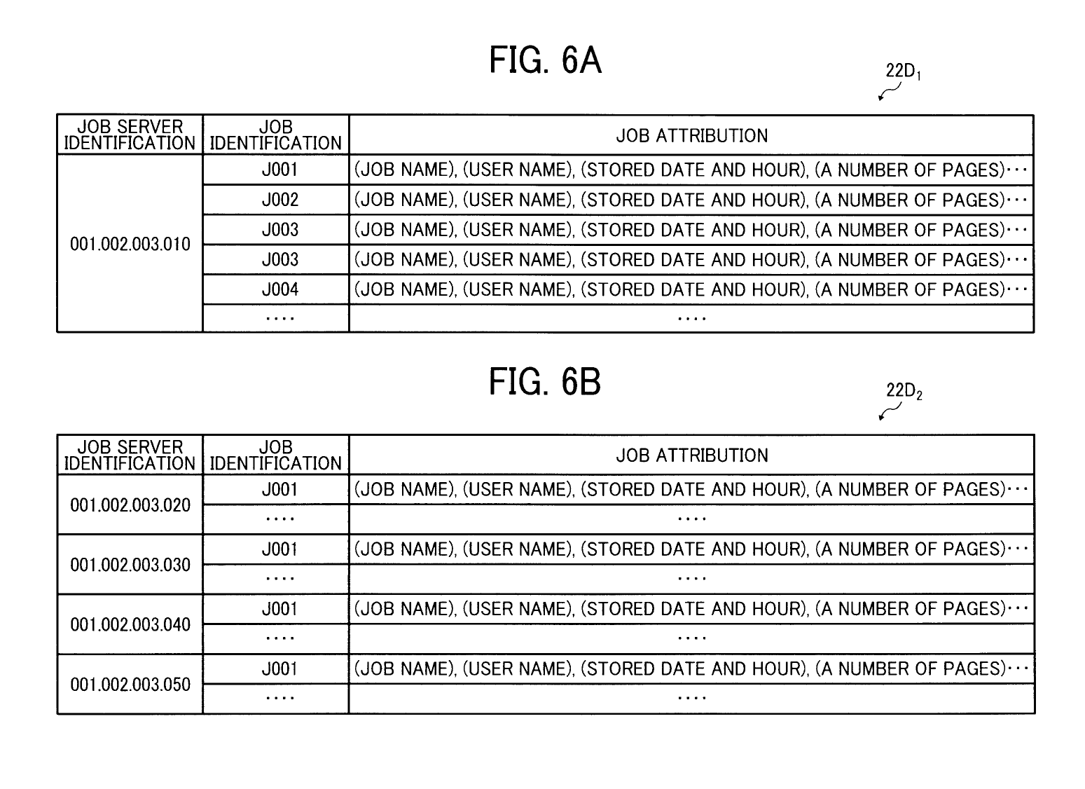

The job list displaying unit 221 is a function unit which displays the job list of the user. When the job list displaying unit 221 receives an operation event requesting a display of the job list, the job list displaying unit 221 requests acquisition of the job list by sending the user identification information and the machine identification information included in the login information to the web server 100. Consequently, the job list displaying unit 221 receives the job list provided by the web server 100. For example, the job list displaying unit 221 receives the job lists 22D1, 22D2 illustrated in the FIG. 6 (collectively referred to as “job list 22D”, hereinafter).

FIG. 6 is a diagram illustrating one example of data of the job list according to this embodiment. As illustrated in FIG. 6, in this embodiment, there are two types of job lists 22D1, 22D2 corresponding to the type of the request for acquiring the job list. The job list 22D1 is provided to the image forming apparatus in response to the request for acquiring the job list from the job server in the same area as the image forming apparatus, and is illustrated in FIG. 6 (A). The job list 22D2 is provided to the image forming apparatus in response to a request to display one or more job lists from job servers in areas different from the area of the image forming apparatus, and is illustrated in FIG. 6 (B).

The job list 22D may include “job server identification”, “job identification”, and “job attribute.” The “job server identification” item may be a network address of job server 300s which provides the job list. The “job identification” item may be an item about the job identification information. The content of the job identification item may be the job ID of the job stored by the user. The “job attribution” item may be an item about the job attribution information. The content of the job attribution item may be, for example, the job name, the user name, the stored time and hour, and a number of pages. When the web server 100 receives the request for acquiring the job list which is sent along with a login of the user, the web server 100 determines the job server 300s set in the area in which the image forming apparatus 200s is set, as the destination (connecting destination) of a request for acquiring the job list. The area S in which the image forming apparatus 200s is set tends to be the area S in which the user is usually located. The user tends to store jobs in the job server 300s set in the area S in which the image forming apparatus 200s is set. So, the web server 100 acquires the job list from the job server 300s set in the area S, because the job server 300s set in the area S tends to store jobs which the user want to execute. So, the job list displaying unit 221 receives the job list 22D1, which is illustrated in FIG. 6(A), including the information of the job stored in the job server 300s corresponding to the server identification information of the job server 300s set in the area S.

When the web server 100 receives the request for acquiring the job list coming along with a request to alter the job server 300s from which the list is obtained, the web server 100 determines the job server 300s set in the area in which the image forming apparatus 200s is not set, as the destination (connecting destination) for the request for acquiring the job list. The job list displaying unit 221 acquires the job list from the other job server 300s rather than the job server 300s set in the area S in which the image forming apparatus 200s is set. The job list displaying unit 221 receives the job list 22D2, which is illustrated in FIG. 6(B), including the information of the jobs stored in the each job server 300s corresponding to the plurality of the server identification information of the job server 300s set in the various areas.

Hereinafter, the job list 22D1 will be referred to as “basic job list (basic display information) 22D1” and job list 22D2 will be referred to as “extended job list (extended display information) 22D2”.

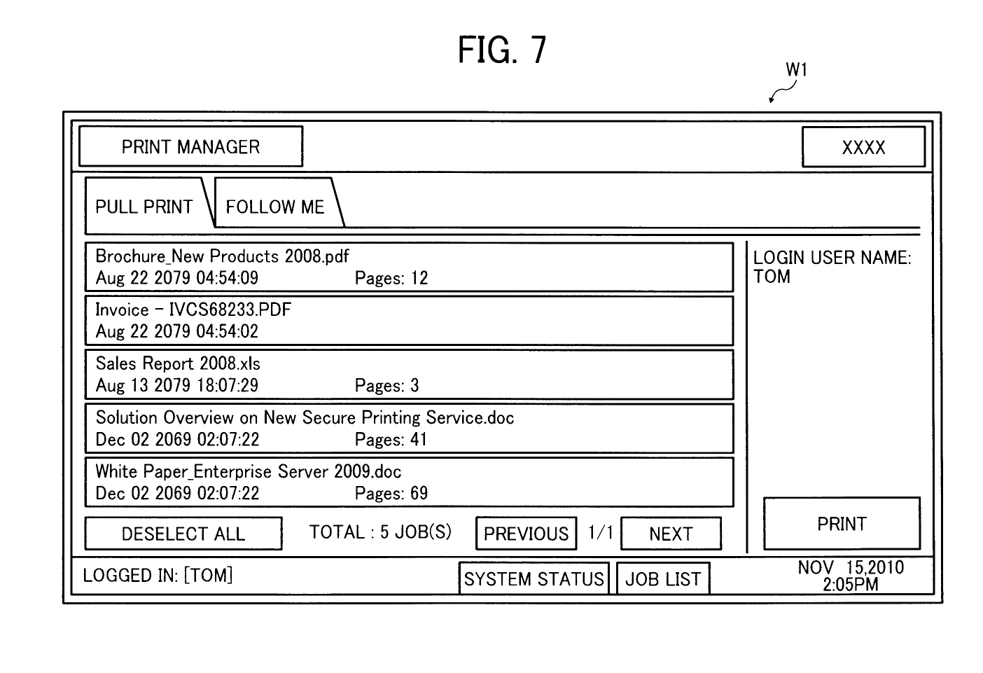

The job list displaying unit 221 displays the job list 22D described above on the operation panel 220. For example, it is displayed as a screen illustrated in FIG. 7.

FIG. 7 is a diagram illustrating one example of job execution operation screen according to this embodiment. An example of the operation screen, on which the user can direct an execution of the job by selecting the job in the job list and designating a “Print” button,” is illustrated in FIG. 7.

Two tab screens are displayed in an operation screen W1. Concretely, a “Pull Print” tab screen and a “Follow Me” tab screen are displayed. These tab screens are displayed to overlap with each other on the screen. The user can selectively display the “Pull Print” tab screen and “Follow Me” tab screen by designating the tab.

For example, on the operation screen illustrated in FIG. 7, the “Pull Print” tab screen display overlaps the “Follow Me” tab screen display.

The “Pull Print” tab screen is a screen transitioned to from the login screen. When the direction of displaying the job list is received, the “Pull Print” tab screen is displayed. So, the basic job list 22D1 is displayed on the “Pull Print” tab screen.

On the other hand, when the user designates the “Follow Me” tab, the “Follow Me” tab screen is displayed over the “Pull Print” tab screen display. In this embodiment, when the “Follow Me” tab is designated, the direction of altering the destination for acquiring the job list is received from the user. So, the extended job list 22D2 is displayed on the “Follow Me” tab screen.

Returning to FIG. 4, the job selection receiving unit 222 is function unit which receives a job selection from the job list. The job selection receiving unit 222 receives the direction of executing the job from the login user. When the job selection receiving unit 222 receives the operation event which selects the execution job, the job selection receiving unit 222 acquires the job identification information of the selected job and the server identification information corresponding to the selected job from the job list 22D. The job selection receiving unit 222 requests the execution job of the login user by sending the job identification information and the server identification information to the web server 100. Consequently, the job acquiring unit 22 receives the job data of the execution job sent from the web server 100.

The job execution unit 23 is function unit which executes the job. The job execution unit 23 executes the job acquired by the job acquiring unit 22. In this embodiment, it is assumed that the execution of the job is printing the job data. The job execution unit 23 sets the various performance settings included in the job data to the plotter 230 of the image forming apparatus 200s and sends a raster image converted from the job data to the plotter 230 for the purpose of printing the job data.

As described above, the printing control function according to this embodiment is realized with a cooperation performance by the function units. Further, the function units described above are realized by the CPU. The CPU reads out programs (software which realizes the printing control function) installed in each apparatus in the system 1 from a storage apparatus (such as “HDD”, “ROM”) to the memory (RAM) and executes a process described below in each apparatus for the purpose of realizing the function units described above.

A detailed process of the printing control function according to this embodiment (the cooperation performance by each of the function units) will be described below with reference to a sequence diagram and a flowchart.

[Main Process of Printing Control]

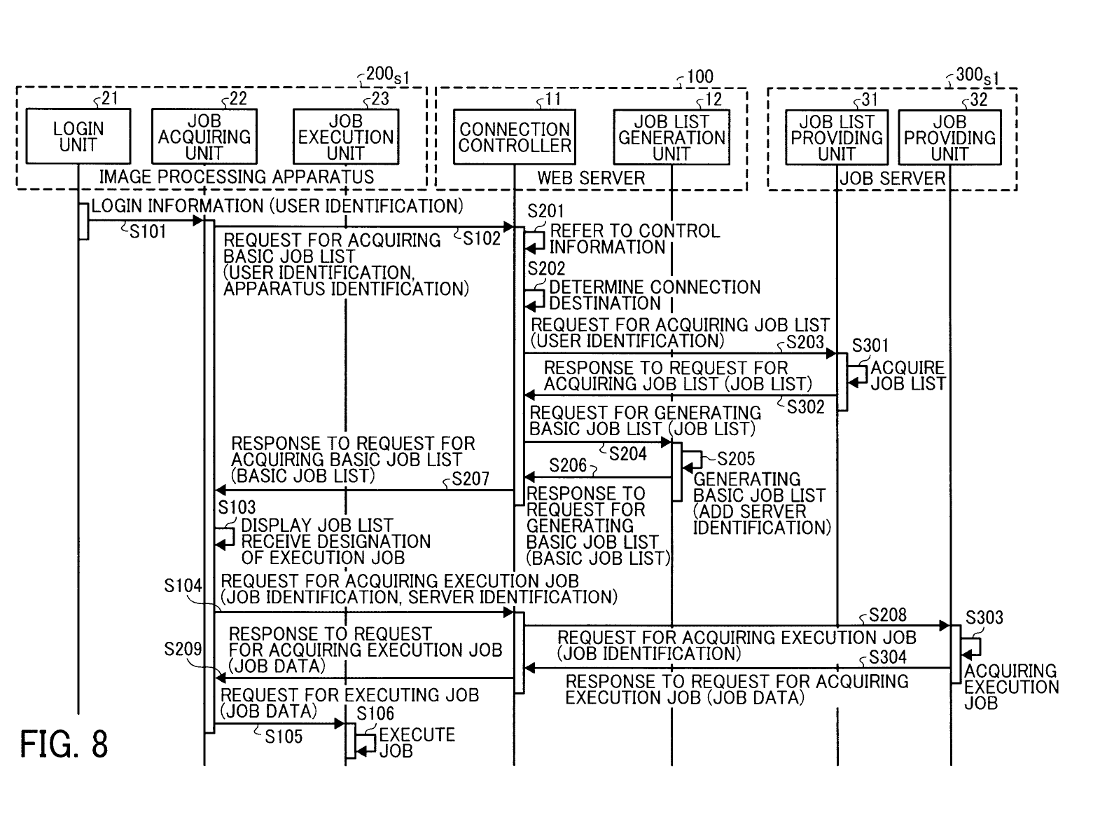

FIG. 8 is a sequence diagram illustrating a procedure for a process of printing control according to this embodiment. The procedure for the process, in the image forming apparatus 200s, from receiving the direction of the execution job to printing is illustrated in FIG. 8.

As illustrated in FIG. 8, the image forming apparatus 200s relays the login information including the user identification information of the user to the job acquiring unit 22 with the login unit 21 (step S101).

Next, when the image forming apparatus 200s receives, on the screen, the direction of displaying the job list of the login user, the image forming apparatus 200s sends a request for acquiring the basic job list 22D1, to the web server 100, that includes the user identification information of the login user and the machine identification information with the job acquiring unit 22 (step S102).

When the web server 100 receives the request for acquiring the basic job list from the image forming apparatus 200s, the web server 100 accesses the control information storing unit 10 and refers to stored control information 10D with the connection controller 11 (step S201). The web server 100 determines the job server 300s for acquiring the basic job list 22D1 (step S202).

In the case in which the machine identification information of the image forming apparatus 200s1 is “001.002.003.011” and the control information 10D illustrated in FIG. 5 is referenced, the connection controller 11 determines the connection destination as described below. The connection controller 11 acquires the area identification information “Japan”, corresponding to the machine identification information received from the image forming apparatus 200s1, with reference to the image processing apparatus information 10D1. Thus, the connection controller 11 determines the set area S1 in which the image forming apparatus 200s1 is set. The connection controller 11 acquires the server identification information “001.002.003.010”, corresponding to the acquired area identification information, with reference to the job server information 10D2. Thus, the connection controller 11 determines the job server 300s1 which is connected to the image forming apparatus 200s1.

Next, the web server 100 sends, with the connection controller 11, a request for acquiring the job list of the login user to the determined job server 300s, the request including the user identification information received from the image forming apparatus 200s1 (step S203).

When the job server 300s1 receives the request for acquiring the job list from the web server 100, the job server 300s1 accesses the job storing unit 23 and acquires the job list 22D including the information of the stored job of the login user with the job list providing unit 31 (step S301). On this occasion, the job list providing unit 31 acquires the job list 22D by extracting the management information, from the management information of the stored job, corresponding to the user identification information received from the web server 100.

Next, the job server 300s1 responds to the request for acquiring the job list by sending, to the web server 100, the job list 22D with the job list displaying unit 221 (step S302).

When the web server 100 receives the job list response from the job server 300s1, the web server 100 sends, with the connection controller 11, a request for generating the basic job list 22D to the job list generating unit, the request including 12 the job list 22D received from the job server 300s1 (step S204).

Next, the web server 100 generates the basic job list 22D1 by adding the server identification information corresponding to the job server 300s1 to the received job list 22D (step S205).

The web server 100 relays the generated job list to the connection controller 11 (step S206).

Next, the web server 100 responds to the request for generating the basic job list by sending the received basic job list 22D1 to the image forming apparatus 200s1 (step S207).

When the image forming apparatus 200s1 receives, from the web server 100, the response to the request for acquiring the basic job list, the image forming apparatus 200s1 displays the received basic job list 22D1 on the screen with the job acquiring unit 22. When the login user designates the job on the screen, the image forming apparatus 200s receives the direction of executing the job from the login user (step S103).

When the direction of executing the job from the login user is received, the job acquiring unit 22 sends a request for acquiring the execution job to the web sever 100, the request including the job identification information of the selected job and the server identification information storing the selected job (step S104). On this occasion, the job acquiring unit 22 acquires the job identification information of the selected job and the server identification information corresponding to the selected job from the basic job list 22D1. The job acquiring unit 22 sends a request for acquiring the job of the login user that includes the acquired job identification information and the acquired server identification information to the web server 100.

When the web server 100 receives the request for acquiring the execution job from the image forming apparatus 200s1, the web server 100 sends, with the connection controller 11, a request for acquiring the execution job that includes the job identification information to the job server 300s1 specified by the server identification information (step S208).

When the job server 300s1 receives the request for acquiring the execution job from the web server 100, the job server 300s accesses the job storing unit 23 and acquires the execution job of the login user with the job providing unit 32 (step S303). On this occasion, the job providing unit 32 acquires the job data corresponding to the job identification information with reference to the management information of the stored job.

Next, the job server 300s1 responds to the request for acquiring the execution job by sending the job data to the web server 100 with the job providing unit 32 (step S304).

When the web server 100 receives the response to request for acquiring the execution job from the job server 300s1, the web server 100 responds to the request for acquiring the execution job by sending the job data received from the job server 300s1 to the image forming apparatus 200s1 (step S209).

When the image forming apparatus 200s receives the response to the request for acquiring the execution job from the web server 100, the image forming apparatus 200s sends a request for executing the job by relaying the job data received from the web server 100 to the job execution unit 23 with the job acquiring unit 22 (step S105).

Thus, in the image forming apparatus 200s1, the job data received by the job execution unit 23 is printed.

[A Process of Management of Displaying the Job List]

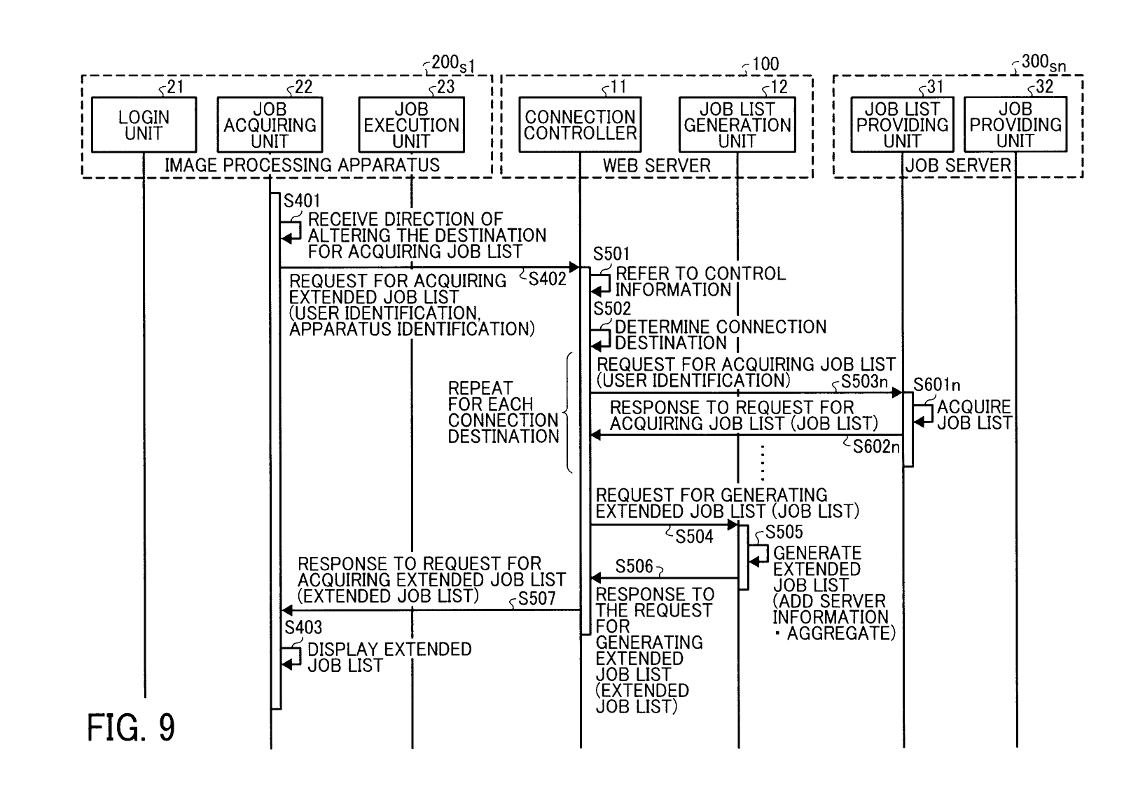

FIG. 9 is a sequence diagram illustrating the procedure for the process of displaying the extended job list according to this embodiment. In the case in which the image forming apparatus 200s1 receives the direction of altering the destination for acquiring the job list in the step S103 illustrated in FIG. 8, this process of displaying the job list is executed.

As illustrated in FIG. 9, when the login user designates the “Follow Me” tab on the screen, the image forming apparatus 200s1 receives the direction of altering the destination for acquiring the job list from the login user (step S401).

When the image forming apparatus 200s1 receives the direction of altering the destination for acquiring the job list from the login user, the image forming apparatus 200s sends a request for acquiring the extended job list 22D1 that includes the user identification information of the login user and the machine identification information to the web server 100 (step S402).

When the web server 100 receives the request for acquiring the extended job list from the image forming apparatus 200s1, the web server 100 accesses the control information storing unit 10 and refers to the control information 10D with the connection controller 11 (step S501). The web server 100 determines the job server 300s for acquiring the extended job list 22D2 as the altered connection destination (step S502).

On this occasion, in the case in which the machine identification information of the image forming apparatus 200s is “001.002.003.011” and the control information 10D illustrated in FIG. 5 is referred to, the connection controller 11 determines the connection destination by the way described below. The connection controller 11 acquires the area identification information “Madrid”-“Paris” that does not correspond to the machine identification information received from the image forming apparatus 200s1 with reference to the image processing apparatus information 10D1 based on the machine identification information received from the image forming apparatus 200s1. The connection controller 11 determines the area Sn which is different from the area S1 in which the image forming apparatus 200s1 is set. The connection controller 11 determines the job server 300s which will be the altered connection destination by acquiring the server identification information “001.002.003.020”-“001.002.003.050” corresponding to the area identification information with reference to the job server information 10D2 based on the acquired the area identification information.

As described above, in the case in which the web server 100 receives a plurality of the server identification information with the connection controller 11, the web server 100 determines a plurality of the job server 300s as the altered connection destination. In this case, the process described below is executed between the web server 100 and each job server 300sn.

The web server 100 sends a request for acquiring the job list of the login user that includes the user identification information received from the image forming apparatus 200s to each job server 300sn (step S503n)

When each job server 300sn receives the request for acquiring the job list from the web server 100, each job server 300sn accesses the job storing unit 23 and acquires the job list 22D including the information of the stored job of the login user with the job providing unit 32 (step S601n). On this occasion, the job list providing unit 31 extracts the management information of the login user from the management information of the stored job based on the user identification information received from the web server 100, and acquires the job list 22D.

Next, the each job server 300sn responds to the request for acquiring the job list by sending the job list 22D to the job server 300s with the job list providing unit 31 (step S602n).

The process described above is executed for a number of the connection destinations determined.

When the web server 100 receives a response to the request for acquiring the job list from each job server 300sn, the web server 100 requests generating the extended job list 22D2 by relaying the plurality of the job lists 22D received from the job servers 300sn to the job list generating unit 12 (step S504).

Next, the web server 100 adds the server identification information of each job server 300sn (the altered connection destination) to the received job list 22D, and generates the extended by job list 22D2 by aggregating (merging) the plurality of job lists 22D including the server identification information with the job list generating unit 12 (step S505). The job list generating unit 12 responds to the request for generating the extended job list by relaying the generated job list 22D2 to the connection controller 11 (step S506).

Next, the web server 100 responds to the request for acquiring the extended job list by sending the received extended job list 22D2 to the image forming apparatus 200s1 with the connection controller 11 (step S507).

When the image forming apparatus 200s receives the response to the request for acquiring the extended job list from the web server 100, the image forming apparatus 200s displays the received extended job list 22D2 on the screen with the job acquiring unit 22 (step S403).

Consequently, in the image forming apparatus 200s1, the operation screen W1 for executing jobs is changed from the screen displaying the list of jobs of the user stored in the job server 300s1 set in the set area S1 in which the image forming apparatus 200s1 is set, to the screen displaying the list of jobs of the user stored in the job server 300sn set in the set areaₛₙ which is different from the set area S1 in which the image forming apparatus 200s1 is set.

As described above, the web server 100 stands communicatively between the plurality of job servers 300n storing the job and the image forming apparatus 200n, and manages the request for acquiring the data and the response processing executed among the two sides of the apparatus.

The web server 100 acquires, responding to the request for acquiring the job list of the user, the job list (the extended job list) 22D2 from the job server 300sn set in the area Sn which is different from the area S1 in which the image forming apparatus 200s1 is located. The web server 100 sends the acquired job list 22D2 to the image forming apparatus 200s1 with the connection controller 11.

Thus, in the image forming apparatus 200s1, the job list displaying unit 221 displays, in the list format, the job of the user stored in the job server 300sn set in the areaₛₙ which is different from the area S1 in which the apparatus is set.

The web server 100 acquires the job data, responding to the request for acquiring the execution job which is received from the image forming apparatus 200s1, from the job server 300sn storing the job corresponding to the direction of executing the job. The web server 100 sends the acquired job data to the image forming apparatus 200s1 with the connection controller 11.

Consequently the job data received by the job execution unit 23 is printed in the image forming apparatus 200s1.

Thus, in the printing control system 1 according to this embodiment, in the case in which the plurality of the job server 300s storing the job is in the different set area S, the user selects the job which the user wants to execute with the image forming apparatus 200s and executes the printing job.

[Second Embodiment]

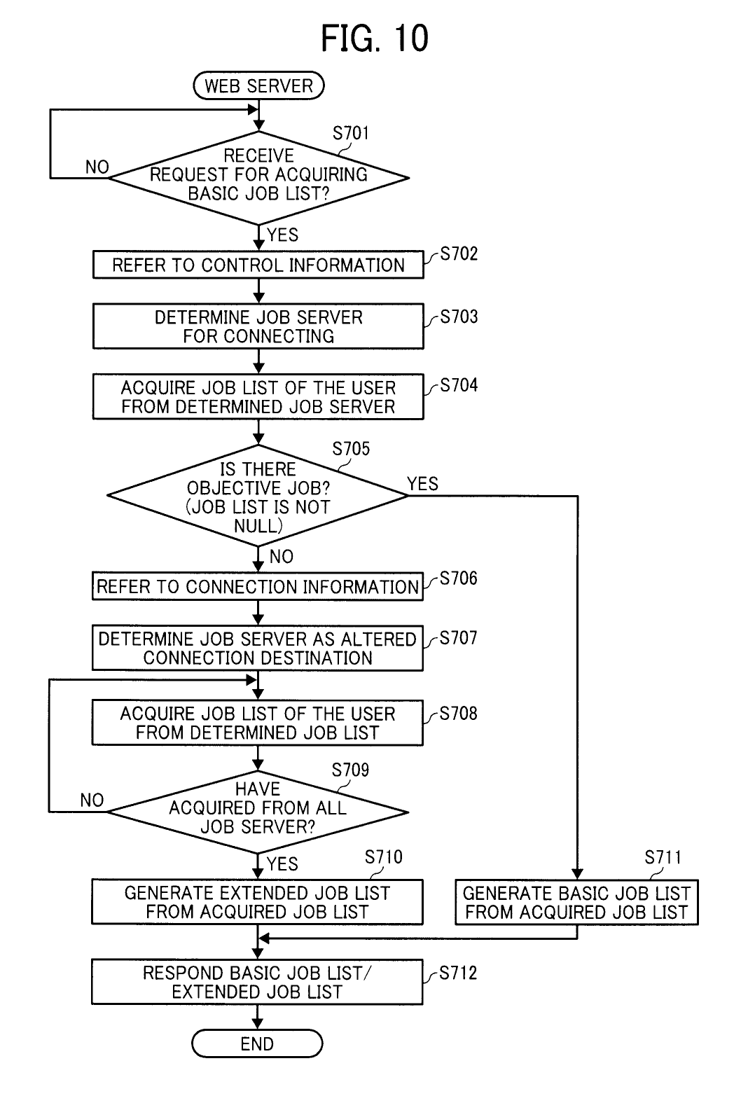

FIG. 10 is a flowchart illustrating the procedure for a process of displaying the basic job list and the extended job list according to this second embodiment. The procedure for a process which is executed at the timing of controlling the display of the job list is illustrated in FIG. 10.

In the procedure of the process illustrated in FIG. 9, when the user designates the “Follow Me” tab on the operation screen W1 for executing the job, the image forming apparatus 200s receives the direction of altering the destination for acquiring the job list. The operation screen W1 for executing jobs is changed from the screen displaying the basic job list, to the screen displaying the extended job list. It means that the switching of the screen displaying the job list is executed in response to the operation on the screen by the login user.

In this second embodiment, it is provided that the procedure for the process of switching from the screen displaying the basic job list to the screen displaying the extended job list is based on whether or not the job server 300s stores the job of the user. The description of this procedure is described below. A discussion of steps that are the same as those in FIGS. 8 and 9 is omitted.

As illustrated in FIG. 10, when the web server 100 receives the request for acquiring the basic job list (step S701:YES), the web server 100 refers to the control information 10D stored in the control information storing unit 10 based on the machine identification information received from the image forming apparatus 200s1 with the connection controller 11 (step S702).

Next, the connection controller 11 determines the job server 300s1 located in area S1 as the connection destination for acquiring the basic job list 22D1 based on the set areas S1 corresponding to the machine identification information (step S703).

Next, the connection controller 11 acquires the job list 22D of the login user from the job server 300s based on the user identification information received from the image forming apparatus 200s1 (step S704).

On this occasion, the connection controller 11 determines whether or not there are any jobs of the login user stored in the job server 300s1 which is connected to the image forming apparatus (step S705). The connection controller 11 confirms whether or not the data of the acquired job list 22D is null.

When the acquired data of the job list 22D is not null, and there is at least one stored job of the login user in the connection destination (step S705:YES), the job list generating unit 12 generates the basic job list 22D1 based on the acquired job list 22D (step S711).

The connection controller 11 responds to the request for acquiring the basic job list by sending the received basic job list 22D1 to the image forming apparatus 200s1 (step S712).

On the other hand, when the acquired data of the job list 22D is null, and there is no stored job of the login user in the connection destination (step S705:NO), the connection controller 11 refers to the control information 10D stored in the control information storing unit 10 again (step S706).

Next, the connection controller 11 determines the job server 300s set in the area Sn which is different than the area S1 corresponding to the machine identification information as the altered connection destination for acquiring the extended job list 22D2 (step S707).

Next, the connection controller 11 acquires the job list 22D of the login user, corresponding to the user identification information received from the image forming apparatus 200s1, from the each determined job server 300sn (step S708).

On this occasion, the connection controller 11 determines whether or not the job list 22D of the user from the all determined job server 300sn is acquired (step S709).

When the connection controller 11 acquires the job list 22D of the user from the all determined job server(s) 300sn (step S709:YES), the job list generating unit 12 generates the extended job list 22D2 based on the plurality of acquired job list(s) 22D (step S710).

Consequently, the connection controller 11 responds to the request for acquiring the basic job list by sending the received extended job list 22D2 to the image forming apparatus 200s1 (step S712).

Thus, in the image forming apparatus 200s1, the job list 22D received from the job server 300s, which stores the stored job of the login user, is displayed on the operation screen of the execution job W1. Further the “Follow Me” tab screen is displayed over the “Pull Print” tab screen on the operation screen of the execution job W1. In the printing control system 1 according to this second embodiment, when there are no stored jobs in the job server 300s set in the set area S in which the image forming apparatus 200s is set, an operation circumstance for executing the job is provided without the user's direction of altering the destination for acquiring the job list by the user's designating the “Follow Me” tab on the screen.

[Third Embodiment ]

In this third embodiment, when the area in which the user belongs to (referred to as a “user belong area”, hereinafter) is the same as an area in which the image forming apparatus 200s that the user is going to use, is located, (referred to as an “apparatus set area”), the basic job list 22D1 is displayed. When the area the user belongs to is not the same as the apparatus set area, the extended job list 22D2 is displayed. A discussion of elements which are similar to those discussed with respect to FIG. 1-FIG. 10 will be omitted for this third embodiment.

[System Configuration]

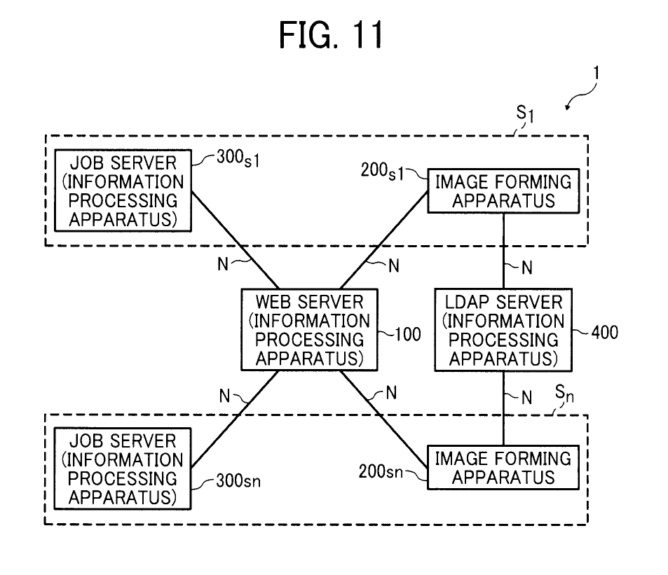

FIG. 11 is a diagram illustrating the printing control system according to this third embodiment. An example of the system configuration including a LDAP server 400 is illustrated in FIG. 11. The LDAP server 400 is an authentication apparatus having a user authentication function. The user authentication function is a function authenticating the user for the image forming apparatus 200s at a timing of the login. The image forming apparatus 200s located in area S is connected to the LDAP server 400 through communication network N. When the image forming apparatus 200s receives a login of the user, the image forming apparatus 200s requests the LDAP server 400 to authenticate the user.

As described above, the printing control system 1 according to this third embodiment, the high-security printing control service is provided by authenticating the user of the image forming apparatus 200s.

[Printing Control Configuration]

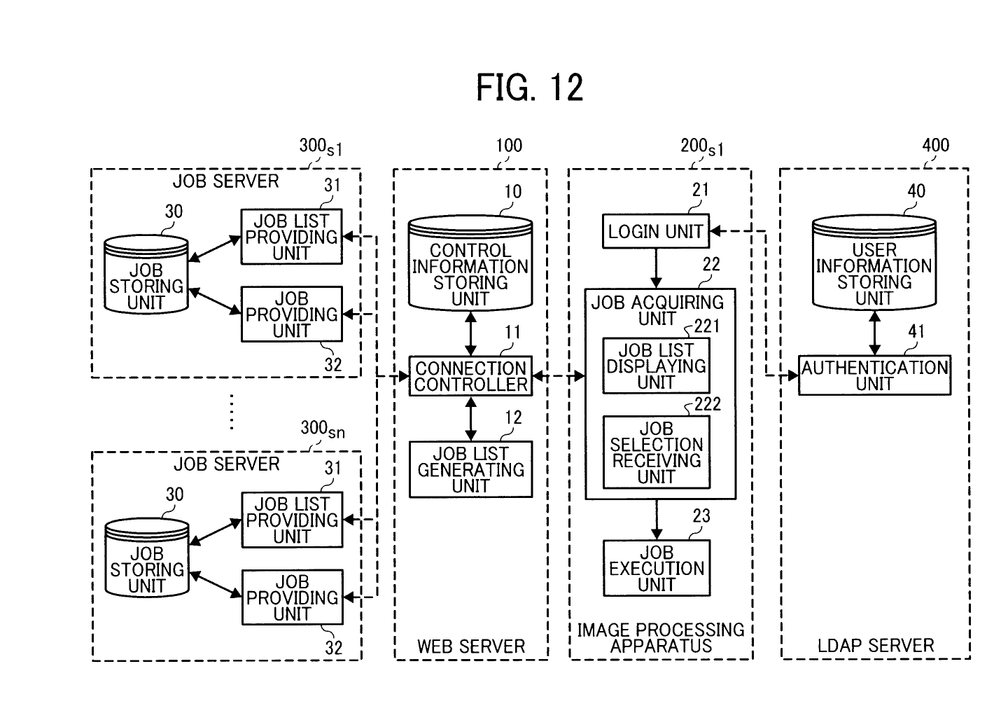

FIG. 12 is a diagram illustrating a function configuration of a printing control according to this third embodiment. As illustrated in FIG. 2, the printing control function according to this third embodiment may include each function unit illustrated in FIG. 4 and authentication unit 41. The authentication unit 41 is a function unit included in the LDAP server 400.

[LDAP Server]

The authentication unit 41 is a function unit which authenticates the user in response to the authentication request. The login unit 21 included in the image forming apparatus 200s requests the user authentication by sending the login information including the user identification information and authentication data to the LDAP server 400. When the authentication unit 41 receives the user authentication request, the authentication unit 41 accesses user information storing unit 40 storing the user information and executes the user authentication based on the login information received from the image forming apparatus 200s. Further the user information storing unit 40 is a storage area of a storage apparatus included in the LDAP server 400.

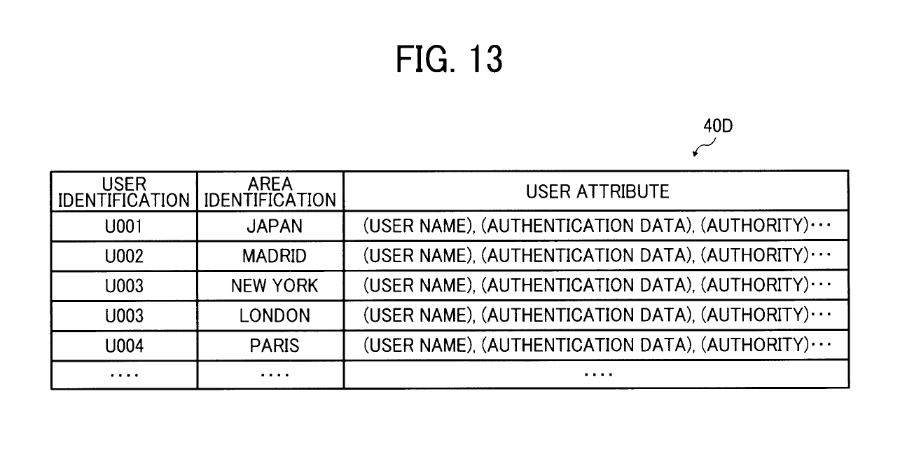

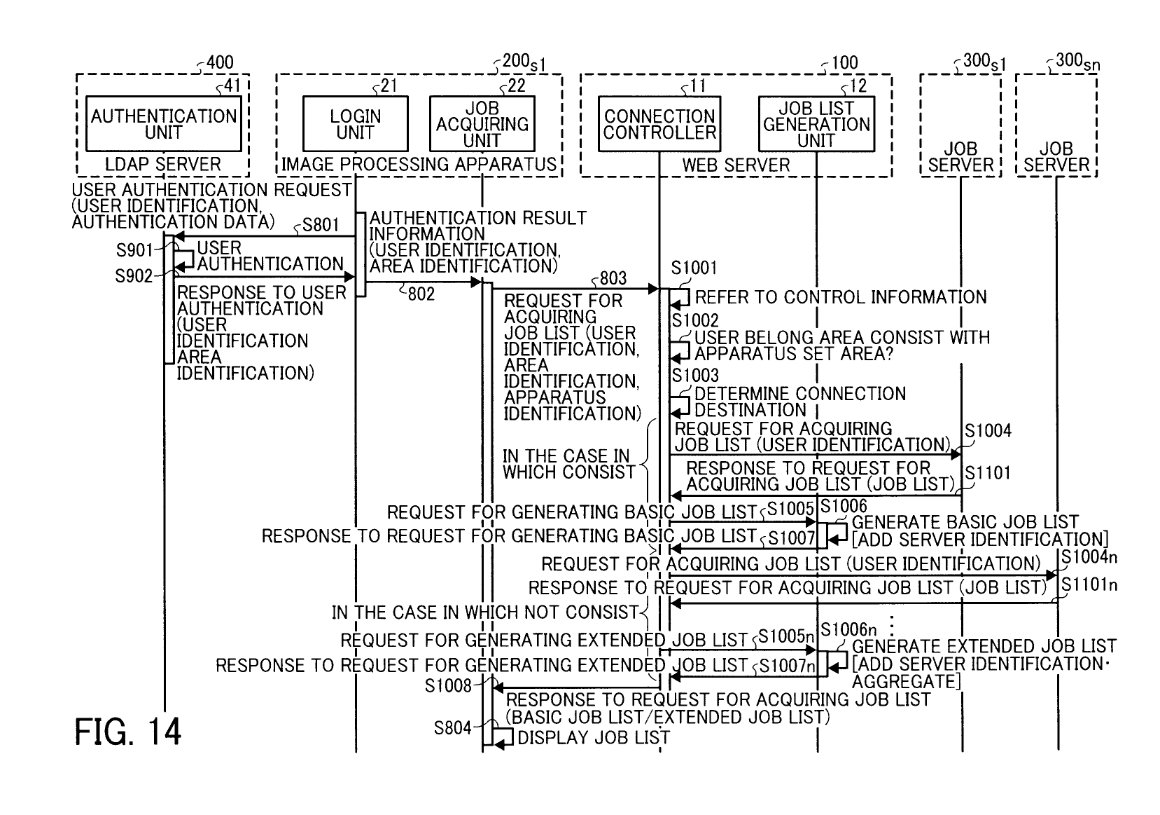

FIG. 13 is a diagram illustrating one example of data of the user information 40D according to this third embodiment. As illustrated in FIG. 13, the user information 40D may include the authentication data for the user. The user information 40D may include information items, corresponding to the each user, such as “the user identification”, “the area identification” and “the user attribution”. The “user identification” item may be an item which stores the user identification information. A content of this item may be something such as the user ID. The “area identification” item may be an item which stores the area identification information that identifies the user belong area. The content of this item may be something such as an area name. The “user attribution” item may be an item which stores information of the user attribution (referred to as “the user attribution information”, hereinafter). The content of the item may include the user name, authentication data, and an authority (a limited availability setting). Further, the contents of these items may be set by the administrator in advance.

Returning to FIG. 12, the authentication unit 41 acquires the user attribution information corresponding to the user identification information(the user attribution information including correspondent the user name), with reference to the user information storing unit 40, based on the user identification information received at the timing of the authentication request. The authentication unit 41 compares the authentication data received at the timing of the authentication request with the authentication data included in the acquired user attribution information. The authentication unit 41 determines whether or not the authentication data received at the timing of the authentication request is consistent with the authentication data included in the acquired user attribution information. The authentication unit 41 executes the user authentication based on the result of the determination. The authentication unit 41 responds to the authentication request by sending the authentication result (permission for use/not permission for use) to the image forming apparatus 200s which requests authentication. On this occasion, when the authenticated user is a permitted user, the authentication unit 41 sends authentication result and the area identification information of the user.

[Image Forming Apparatus]

When the login unit 21 receives the authentication result denoting the authenticated user is a permitted user from the LDAP server 400, the job acquiring unit 22 performs as described below. When the job acquiring unit 22 receives the operation event directing the display of job list, the job acquiring unit 22 sends a requests to acquire the job list by sending the user identification information, the area identification information of the user and the machine identification information of the image forming apparatus 200s included in the login information acquired by the login unit 21 to the web server 100 with the job list displaying unit 221.

[Web Server]

When the connection controller 11 receives the request to acquire the job list from the image forming apparatus 200s, the connection controller 11 accesses the control information storing unit 10 storing the control information 10D, and controls a connection between the job server 300s and the image forming apparatus 200s based on the connection rule set in the control information 10D. On this occasion, the connection controller 11 determines whether or not the area information acquired based on the machine identification information from the control information 10D (area information indicates the area in which apparatus is set) is consistent with the area information of the user received at the timing of the request for acquiring by comparing the area information acquired based on the machine identification information from the control information 10D (area information indicates the area in which apparatus is set) with the area information of the user received at the timing of the request for acquiring. The connection controller 11 determines whether or not the user belong area is consistent with the apparatus set area based on the result of the determination.

When the user belong area is consistent with the apparatus set area, the connection controller 11 determines the job server 300s set in the area S1 in which the image forming apparatus 200s, which sends the request for acquiring the job list, is set as the connection destination based on the connection rule set in the control information 10D. The connection controller 11 requests for acquiring the basic job list 22D1 to the determined job server 300s.

On the other hand, when the user belong area is not consistent with the apparatus set area, the connection controller 11 determines the job server 300s set in the areaₛₙ in which the image forming apparatus 200s, which sends the request for acquiring the job list, is not set as the connection destination based on the connection rule set in the control information 10D. The connection controller 11 requests for acquiring the extended job list 22D1 to the determined job server 300sn.

[Process of Display Control of the Job List]

FIG. 14 is a flowchart illustrating a procedure for a display control of the basic job list and the extended job list according to this another embodiment. As illustrated in FIG. 14, when the image forming apparatus 200s1 receives the login information of the user through the login screen, the image forming apparatus 200s requests for the user authentication by sending the user identification information of the login user and the authentication data to the LDAP server 400 with the login unit 21 (step S801).

When the LDAP server 400 receives the user authentication request from the image forming apparatus 200s1, the LDAP server 400 accesses the user information storing unit 40 with the authentication unit 41. The LDAP server 400 refers to the user information 40D stored in the user information storing unit 40, and executes the user authentication based on the user identification information of the login user (step S901). The authentication unit 41 compares the authentication data received at the timing of the authentication request with the authentication data included in the user attribution information acquired from the user information storing unit 40 based on the user identification information of the login user. The authentication unit 41 determines whether or not the authentication data received at the timing of the authentication request is consistent with the authentication data included in the acquired user attribution information. The authentication unit 41 executes the user authentication based on the result of the determination.

The authentication unit 41 responds to the authentication request by sending the authentication result (permission for use/not permission for use) to the image forming apparatus 200s which requests authentication with the authentication unit 41 (step S902). On this occasion, when the authenticated user is a permitted user, the authentication unit 41 sends authentication result and the area identification information of the user.

When the image forming apparatus 200s1 receives the response to the user authentication request from the LDAP server 400, the image forming apparatus 200s determines whether or not the user requesting the authentication is the permitted user with the login unit 21. In the case in which the user requesting the authentication is the permitted user, the image forming apparatus 200s relays the authentication result information, received from the LDAP server 400, including the area identification information of the user to the job acquiring unit 22 (step S802).

The image forming apparatus 200s1 requests for acquiring the job list 22D by sending, with the job acquiring unit 22, the user identification information of the login user, the area identification information of the user and the machine identification information of the apparatus to the web server 100 (step S803).

When the web server 100 receives the request for acquiring the job list from the image forming apparatus 200s1, the web server 100 accesses the control information storing unit 10 with the connection controller 11, and refers the control information 10D (step S1001).

The web server 100 determines whether or not the user belong area is consistent with the apparatus set area based on the area identification information denoting the user belong area and the area identification information denoting the apparatus set area in which the image forming apparatus 200s1 is set (step S1002). On this occasion, the connection controller 11 determines whether or not the area information acquired based on the machine identification information from the control information 10D (area information indicates the area S1 in which the image forming apparatus 200s is set) is consistent with the area information of the user received at the timing of the request for acquiring by comparing the area information acquired based on the machine identification information from the control information 10D (area information indicates the area in which the image forming apparatus 200s is set) with the area information of the user received at the timing of the request for acquiring.

When the user belong area is consistent with the apparatus set area, the web server 100 determines, with the connection controller 11, the job server 300s set in the area S1 in which the image forming apparatus 200s, which sends the request for acquiring the job list, is set as the connection destination. On the other hand, when the user belong area is not consistent with the apparatus set area, the web server 100 determines, with the connection controller 11, the job server 300s set in the area Sn in which the image forming apparatus 200s, which sends the request for acquiring the job list, is not set as the connection destination (step S1003).

[In the Case in Which it is Consistent]

The web server 100 requests for acquiring the job list 22D of the login user by sending the user identification information received from the image forming apparatus 200s1 to the determined job server 300sn with the connection controller 11 (step S1004).

The web server 100 acquires, based on the user identification information received from the image forming apparatus 200s, the job list 22D of the login user from the determined job server 300s with the connection controller 11 (step S1101).

Next, when the web server 100 receives the job list response from the job server 300s, the web server 100 relays, with the connection controller 11, the job list 22D received from the job server 300s1 to the job list generating unit 12 and requests that the basic job list 22D1 be generated(step S1005).

Next, the web server 100 generates the basic job list 22D1 by adding, with the job list generating unit 12, the server identification information of the job server 300s1 to the received job list 22D1 (step S1006). The job list generating unit 12 responds to the request for generating the basic job list by relaying the generated basic job list 22D1 to the connection controller 11 (step S1007).

[In the Case in Which it is Not Consistent]

The web server 100 sends requests to acquire the job list 22D of the login user by sending, with the connection controller 11, the user identification information received from the image forming apparatus 200s1 to the each job server 300sn determined (step S1004n).

The web server 100 acquires the job list 22D of the login user from the job server 300sn, based on the user identification information received from the image forming apparatus 200s, with the connection controller 11 (step S1101n).

Next, when the web server 100 receives the job list response from the each the job server 300sn, the web server 100 relays the plurality of the job list 22D to the job list generating unit 12 and requests the extended job list 22D2 be generated with the connection controller 11 (step S1005n). Next, the web server 100 generates the extended job list 22D2, with the job list generating unit 12, by adding the each server identification information of the each job server 300sn to the each job list 22D received by the job list generating unit 12 and aggregating (merging) the plurality of the job lists to the one job list 22D (step S1006n).

The job list generating unit 12 responds to the request for generating the extended job list by relaying the generated extended job list 22D2 to the connection controller 11 (step S1007).

Next, the web server 100 responds to the request for acquiring the job list by sending the received job list 22D (basic/extended job list) to the image forming apparatus 200s1 with the connection controller 11 (step S1008).

When the image forming apparatus 200s1 receives the response to the request for acquiring the job list from the web server 100, the image forming apparatus 200s displays, with the job acquiring unit 22, the received job list 22D (basic/extended job list) on the screen (step S804).

Thus, in the case in which the apparatus is set in the user belong area, the job list 22D acquired from the job server 300s set in the user belong area is preferentially displayed on the operation screen for executing the job W1 in the image forming apparatus 200s. In the case in which the apparatus is not set in the user belong area, the job list 22D acquired from the job server 300sn which is not set in the user belong area is preferentially displayed on the operation screen for executing the job W1 in the image forming apparatus 200s. Consequently, in the printing control system 1, an operation circumstance for executing the job in which the user can easily find the job which the user want to execute can be provided to the user.

“the printing control function” according to the embodiment described above may be realized by the central processing unit (CPU) implemented in the each apparatus (“the web server”, “the job server”, “the image forming apparatus”) executes the programs, for the procedure of process described above, coded with program language which is suitable to the performance circumstance (platform).

For example, the programs for the web server 100 can be stored in storage medium 103a which can be read by the computer. Thus, the programs can be installed in the web server 100 through the drive unit 103. The programs for the image forming apparatus 200s can be stored in storage medium 214a. Thus, the programs can be installed in the image forming apparatus 200s through the external storage I/F 214. Further, because of that the web server 100 including the interface unit 107 and the image forming apparatus 200s including the network I/F 213, the web server 100 and the image forming apparatus 200s can download the programs through the network and install the programs.

Further, in the embodiments described above, the printing control system whose image processing apparatus 200 acquires the printing job stored in the web server 100 and executes the acquired printing job is explained. However, other embodiments are possible that do not involve printing. For example, an image data may be stored in the web server 100 as the job. An image processing device 200, such as an image projection device or image display device, may acquire the image data and project or display the acquired image data.

Thus, functions described in the embodiments discussed herein may be applied to jobs other than printing.

Finally, the embodiments described herein are only examples, and variations and modifications may be made without departing from the concepts discussed herein.

What is claimed is:

1. A information processing apparatus which is connected to a plurality of job servers storing a plurality of jobs and a plurality of image forming apparatuses executing the jobs through a communication network, comprising:
a communication interface that receives a request for a job list of a user from an image forming apparatus; and
a controller unit that controls a request for acquiring the jobs and a response to the request executed between the image forming apparatuses and the job servers;
wherein
the controller unit acquires display information which includes the job list of the user, from a job server located in a area which is different from an area in which the image forming apparatus is located, based on a request for acquiring the display information received from the image forming apparatuses, and transmits the display information to the image forming apparatus, and
the controller unit acquires job data from the job server storing the job which is designated for execution based on a request for acquiring an execution job received from the image forming apparatus, and
the controller unit transmits the job data to the image forming apparatus.

2. The information processing apparatus as claimed in claim 1,
further comprising:
a control information storing unit that stores control information including image forming apparatus information including area identification information that indicates the area and machine identification information that indicates the image forming apparatus and job server information including the area identification information and server identification information that indicates the job server, wherein
the controller unit switches to another the job server to acquire the display information, based on the machine identification information received from the image forming apparatus at the timing of the request for acquiring the display information and the control information stored in the control information storing unit at the timing of the request for acquiring the display information.

3. The information processing apparatus as claimed in claim 2,
wherein
the controller unit
acquires the area identification information corresponding to the machine identification information with reference to the image processing apparatus information based on the machine identification information received from the image forming apparatus,
acquires the server identification information which dose not correspond to the area identification information with reference to the job server information based on the area identification information,
determines the job server corresponding to the server identification information as a connection destination for acquiring the display information, and
acquires extended display information denotes the job list by sending the user identification information to the job server.

4. The information processing apparatus as claimed in claim 3,
wherein
the controller
acquires the area identification information corresponding to the machine identification information with reference to the image processing apparatus information based on the machine identification information received from the image forming apparatus,
acquires the server identification information which correspond to the area identification information with reference to the job server information based on the area identification information,
determines the job server corresponding to the server identification information as a connection destination for acquiring the display information, and
acquires extended display information denotes the job list by sending the user identification information to the job server.

5. The information processing apparatus as claimed in claim 3,
wherein
in a case in which the job server located in the area in which the image forming apparatus is located does not store the job of the user, the controller unit acquires extended display information from the job server set in an area which is different from the area in which the image forming apparatus is located.

6. The information processing apparatus as claimed in claim 1,
further comprising:
an aggregating unit that aggregates the plurality of display information to a consolidated display information;
wherein
in a case in which the controller unit acquires the plurality of the display information, the aggregating unit aggregates the plurality of display information to the consolidated display information, and
the controller unit transmits the consolidated display information to the image forming apparatus.

7. The information processing apparatus as claimed in claim 1,
wherein
the controller unit determines whether or not the area in which the image forming apparatus is located is consistent with an area the user belongs to, and
the controller unit switches to another job server to acquire the display information based on the result of the determination of whether or not the area in which the image forming apparatus is located is consistent with the area the user belongs to.

8. The information processing apparatus as claimed in claim 7,
further comprising:
a control information storing unit that stores control information including image forming apparatus information comprising of area identification information which indicates the area and machine identification information that indicates the image forming apparatus and job server information including area identification information and server identification information that indicates the job server,
wherein
the controller unit determines whether or not the area in which the image forming apparatus is located is consistent with an area the user belongs to, and
in a case in which the area in which the image forming apparatus is located is not consistent with the area the user belongs to, the controller unit communicates with a job server located in an area which is different from the area in which the image forming apparatus is located to acquire the display information, and
the controller unit acquires the extended display information from the job server located in the area which is different from the area in which the image forming apparatus is located.

9. The information processing apparatus as claimed in claim 8,
wherein
the controller unit determines whether or not the area in which the image forming apparatus is located is consistent with an area the user belongs to, and
in a case in which the area in which the image forming apparatus is located is consistent with the area the user belongs to, the controller unit communicates with the job server located in the area where the image forming apparatus is located to acquire the display information, and
the controller unit acquires basic display information from the job server in the area in which the image forming apparatus is located.

10. A job control system comprising:
a plurality of job servers that store a plurality of jobs;
a plurality of image forming apparatuses that execute the jobs; and
an information processing apparatus connected to the plurality of job servers and the plurality of image forming apparatuses through a communication network,
the information processing apparatus includes:
a communication interface that receives a request for a job list of a user from an image forming apparatus; and
a controller unit that controls a request for acquiring the jobs and a response to the request executed between the image forming apparatuses and the job servers;
wherein
the controller unit acquires display information which includes the job list of the user, from a job server located in a area which is different from an area in which the image forming apparatus is located, based on a request for acquiring the display information received from the image forming apparatuses, and transmits the display information to the image forming apparatus, and
the controller unit acquires job data from the job server storing the job which is designated for execution based on a request for acquiring an execution job received from the image forming apparatus, and
the controller unit transmits the job data to the image forming apparatus.

11. A job control method executed in information processing apparatus which is connected to a plurality of job servers storing a plurality of jobs and a plurality of image forming apparatuses executing the jobs through a communication network, said method comprising:
receiving, with a communication interface, a request for a job list of a user from an image forming apparatus;
controlling, with a controller unit, a request for acquiring the jobs and a response to the request for the job list;
acquiring, with the controller unit, display information which includes the job list of the user, from a job server located in a area which is different from an area in which the image forming apparatus is located, based on a request for acquiring the display information received from the image forming apparatus;
transmitting, with the controller, the display information to the image forming apparatus;
acquiring, with the controller unit, job data from the job server storing the job which is designated for execution based on a request for acquiring an execution job received from the image forming apparatus; and
transmitting, by the controller unit, the job data to the image forming apparatus.
